(19) United States
(12) Patent Application Publication
(10) Pub. No.: US 2019/0140733 A1
(43) Pub. Date: May 9, 2019

(54) RADIO FREQUENCY SIGNAL BOOSTERS FOR HIGH FREQUENCY CELLULAR COMMUNICATIONS

(71) Applicant: Cellphone-Mate, Inc., Fremont, CA (US)

(72) Inventor: Hongtao Zhan, Fremont, CA (US)

(21) Appl. No.: 16/139,874

(22) Filed: Sep. 24, 2018

Related U.S. Application Data
(60) Provisional application No. 62/563,251, filed on Sep. 26, 2017.

(51) Int. Cl. H04B 7/155; H04B 1/56; H04B 1/3888; H04B 1/50; H01Q 1/52; H04W 16/26; H04B 1/036

(52) U.S. Cl. CPC H04B 7/15535; H04B 7/1555; H04B 1/56; H04B 7/15507; H04B 1/036; H04B 1/50; H01Q 1/526; H04W 16/26; H04B 1/3888

(57) ABSTRACT

RF signal boosters for high frequency cellular communications are provided herein. In certain embodiments, a signal booster system includes an outdoor base station antenna for communicating with base stations of a cellular network, and an indoor mobile station antenna for communicating with user equipment (UE) of the cellular network, such as mobile phones. The signal booster system further includes a signal booster that is coupled to the indoor mobile station antenna via a cable. The signal booster includes booster circuitry for providing amplification to RF signals associated with one or more uplink and downlink channels of the cellular network. The signal booster further includes a signal conversion circuit operable to provide signal conversion such that RF signals provided to and received from the indoor mobile station antenna via the cable are of lower frequency relative to RF signals provided to and received from the outdoor base station antenna.

### REFERENCE TO RELATED CASES

This application claims the benefit of priority under 35 U.S.C. § 119 of U.S. Provisional Patent Application No. 62/563,251, filed Sep. 26, 2017 and titled “RADIO FREQUENCY SIGNAL BOOSTERS FOR HIGH FREQUENCY CELLULAR COMMUNICATIONS,” which is herein incorporated by reference in its entirety.

### FIELD

Embodiments of the invention relate to electronic systems and, in particular, to radio frequency (RF) signal boosters.

### BACKGROUND

A cellular or mobile network can include base stations for communicating with wireless devices located within the network's cells. For example, base stations can transmit signals to wireless devices via a downlink (DL) channel and can receive signals from the wireless devices via an uplink (UL) channel.

A wireless device may be unable to communicate with any base stations when located in a portion of the mobile network having poor or weak signal strength. To improve a network's signal strength and/or coverage, a radio frequency (RF) signal booster can be used to amplify signals in the network. For example, the signal booster can be used to amplify or boost signals having frequencies associated with the frequency ranges of the network's uplink and downlink channels.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description of Embodiments” one will understand how the features of this invention provide advantages that include improved communications between base stations and mobile devices in a wireless network.

In one aspect, a signal booster system includes a base station antenna configured to wirelessly receive an incoming downlink signal from one or more base stations of a cellular network. The signal booster system further includes a signal booster including booster circuitry configured to amplify the incoming downlink signal to generate a boosted downlink signal, and a signal conversion circuit configured to convert the boosted downlink signal to an outgoing downlink signal of lower frequency. The signal booster system further includes a mobile station antenna configured to receive the outgoing downlink signal from the signal booster via a cable, and to wirelessly transmit the outgoing downlink signal to one or more mobile devices of the cellular network.

In another aspect, a method of signal boosting is provided. The method includes wirelessly receiving an incoming downlink signal from one or more base stations of a cellular network, amplifying the incoming downlink signal to generate a boosted downlink signal using booster circuitry of a signal booster, converting the boosted downlink signal to an outgoing downlink signal of lower frequency using a signal conversion circuit of the signal booster, receiving the outgoing downlink signal using a mobile station antenna over a cable, and wirelessly transmitting the outgoing downlink signal to one or more mobile devices of the cellular network using the mobile station antenna.

In another aspect, a signal booster system installed in a building is provided. The signal booster system includes a base station antenna outside the building and configured to wirelessly receive an incoming downlink signal. The signal booster system further includes a signal booster outside the building. The signal booster includes booster circuitry configured to amplify the incoming downlink signal to generate a boosted downlink signal, and a signal conversion circuit configured to convert the boosted downlink signal to an outgoing downlink signal of lower frequency. The signal booster system further includes a mobile station antenna inside of the building configured to receive the outgoing downlink signal from the signal booster via a cable, and to wirelessly transmit the outgoing downlink signal.

In another aspect, a signal booster system is provided. The signal booster system including a base station antenna configured to wirelessly receive an incoming downlink signal from one or more base stations of a cellular network. The signal booster system further includes a signal booster including booster circuitry configured to amplify the incoming downlink signal to generate a boosted downlink signal, and a first signal conversion circuit configured to process the boosted downlink signal to generate a converted downlink signal of lower frequency. The signal booster system further includes a unit configured to receive the converted downlink signal from the signal booster via a cable. The unit includes a second signal conversion circuit configured to process the converted downlink signal to generate an outgoing downlink signal of higher frequency. The signal booster system further includes a mobile station antenna configured to wirelessly transmit the outgoing downlink signal to one or more mobile devices of the cellular network.

In another aspect, a method of signal boosting is provided. The method include wirelessly receiving an incoming downlink signal from one or more base stations of a cellular network using a base station antenna, amplifying the incoming downlink signal to generate a boosted downlink signal using booster circuitry of a signal booster, converting the boosted downlink signal to generate a converted downlink signal of lower frequency using a first signal conversion circuit of the signal booster, receiving the converted downlink signal from the signal booster at a unit via a cable, converting the converted downlink signal to generate an outgoing downlink signal of higher frequency using a second signal conversion circuit of the unit, and wirelessly transmitting the outgoing downlink signal to one or more mobile devices of the cellular network using a mobile station antenna.

In another aspect, a signal booster system installed in a building is provided. The signal booster system includes a base station antenna outside the building and configured to wirelessly receive an incoming downlink signal from one or more base stations of a cellular network. The signal booster system further includes a signal booster outside the building and including booster circuitry configured to amplify the incoming downlink signal to generate a boosted downlink signal, and a first signal conversion circuit configured to process the boosted downlink signal to generate a converted downlink signal of lower frequency. The signal booster system further includes a unit inside the building and configured to receive the converted downlink signal from the signal booster via a cable. The unit includes a second signal conversion circuit configured to process the converted downlink signal to generate an outgoing downlink signal of higher frequency. The signal booster system further includes a mobile station antenna inside of the building and configured to wirelessly transmit the outgoing downlink signal to one or more mobile devices of the cellular network.

### BRIEF DESCRIPTION OF THE DRAWINGS

FIG. 1 is a schematic diagram of a signal booster system according to one embodiment.

FIG. 2A is a schematic diagram of a signal booster system according to another embodiment.

FIG. 2B is a schematic diagram of a signal booster system according to another embodiment.

FIG. 2C is a schematic diagram of a signal booster system according to another embodiment.

FIG. 2D is a schematic diagram of a signal booster system according to another embodiment.

FIG. 3 is a schematic diagram of a signal booster system according to another embodiment.

FIG. 4 is a schematic diagram of a mobile network according to one embodiment.

FIG. 5A is a side view of one embodiment of an outdoor signal booster.

FIG. 5B is a side view of another embodiment of an outdoor signal booster.

FIG. 5C is a side view of another embodiment of an outdoor signal booster.

FIG. 5D is a side view of another embodiment of an outdoor signal booster.

FIG. 5E is a side view of another embodiment of an outdoor signal booster.

FIG. 5F is a side view of another embodiment of an outdoor signal booster.

FIG. 6 is a schematic diagram of circuitry for connecting to a shared DC power and RF cable, according to one embodiment.

FIG. 7 is a perspective view of one example of a shared DC power and RF cable for a signal booster system.

FIG. 8 is a schematic diagram of a signal booster system according to another embodiment.

FIG. 9 is a schematic diagram of a signal booster system according to another embodiment.

FIG. 10A is a schematic diagram of a signal booster system according to another embodiment.

FIG. 10B is a schematic diagram of a signal booster system according to another embodiment.

FIG. 11A is a schematic diagram of a signal booster system according to another embodiment.

FIG. 11B is a schematic diagram of a signal booster system according to another embodiment.

FIG. 12 is a schematic diagram of a signal booster system according to another embodiment.

FIG. 13A is a schematic diagram of one embodiment of booster circuitry.

FIG. 13B is a schematic diagram of another embodiment of booster circuitry.

FIG. 14 is a schematic diagram of one embodiment of an amplification circuit.

### DETAILED DESCRIPTION OF EMBODIMENTS

Various aspects of the novel systems, apparatus, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatus, and methods disclosed herein, whether implemented independently of, or combined with, any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Installing a signal booster system in a building can advantageously improve both downlink signal strength and uplink signal strength of mobile devices within the building. For example, walls of buildings can have a shielding effect on signals transmitted and received by mobile devices indoors. Furthermore, buildings can include metal, such as beams, pipes, brackets, nails, and screws that operate to inhibit propagation of radio waves.

The shielding effect of buildings can attenuate downlink signals from the base station within the buildings and/or attenuate uplink signals transmitted from within the buildings. Under most conditions, the shielding effect can cause signal strength to drop. In one example, the shielding effect reduces signal strength below a threshold for cellular communication, thereby preventing successful voice and/or data communication. In another example, mobile devices operate with higher transmit power to compensate for a loss in signal strength from shielding, and thus operate with greater power consumption and reduced battery life. In yet another example, the mobile device operates with lower signal quality, and thus lower data rate and/or lower voice quality.

The amount of signal attenuation provided by buildings is frequency dependent, and often increases with signal frequency. Thus, the impact of the shielding effect of buildings is exacerbated in high frequency cellular communications, such as cellular networks communicating using frequencies of 6 GHz or higher. For example, millimeter wave signals, such as certain signals used in fifth generation (5G) technologies, can suffer from very high loss when propagating through walls, windows, and/or other building structures.

To provide indoor cellular signal coverage, a base station antenna can be placed on a roof of a building to achieve a robust communication link with a base station, such as line-of-sight communication. Additionally, a signal booster and a mobile station antenna can be placed inside of the building, and used to communicate with mobile devices therein.

However, in such an implementation, a length of a cable between the base station antenna and the signal booster can be several meters long, resulting in significant cable loss. Such cable loss can reduce transmit power and/or degrade receiver sensitivity. Moreover, cable loss is frequency dependent, and can be particularly exacerbated when the cable carries RF signals over 6 GHz, such as millimeter wave signals in the frequency range of 30 GHz to 300 GHz.

RF signal boosters for high frequency cellular communications are provided herein. In certain embodiments, a signal booster system includes an outdoor base station antenna for communicating with base stations of a cellular network, and an indoor mobile station antenna for communicating with user equipment (UE) of the cellular network, such as mobile phones. The signal booster system further includes a signal booster that is coupled to the indoor mobile station antenna via a cable. The signal booster includes booster circuitry for providing amplification to RF signals associated with one or more uplink and downlink channels of the cellular network. The signal booster further includes a signal conversion circuit operable to provide signal conversion such that RF signals provided to and received from the indoor mobile station antenna via the cable are of lower frequency relative to RF signals provided to and received from the outdoor base station antenna.

By including the signal conversion circuit, communications between the signal booster and the indoor mobile station antenna are achieved with lower signal loss, since RF signals communicated over the cable are of reduced frequency and thus suffer from less cable attenuation. Thus, mobile devices inside of the building can realize superior cellular signal strength even in applications in which at least a portion of signals transmitted and received by the base stations of the cellular network are 6 GHz or more, for instance, millimeter wave frequencies.

In certain configurations, the signal conversion circuit operates to provide conversion between RF signals over 6 GHz and RF signals of less than 6 GHz. Thus, signal loss associated with transmitting and received high frequency RF signals over an RF cable is reduced or avoided.

In one embodiment, the signal conversion circuit provides conversion between a high frequency licensed cellular signal, such as a 5G cellular signal, and a lower frequency unlicensed signal, such as a WiFi signal. Accordingly, mobile devices inside of the building can communicate with the indoor mobile station antenna via WiFi signaling, while the signal booster can communicate with the base stations of the cellular network using 5G technology, including, but not limited to, 5G millimeter wave communications.

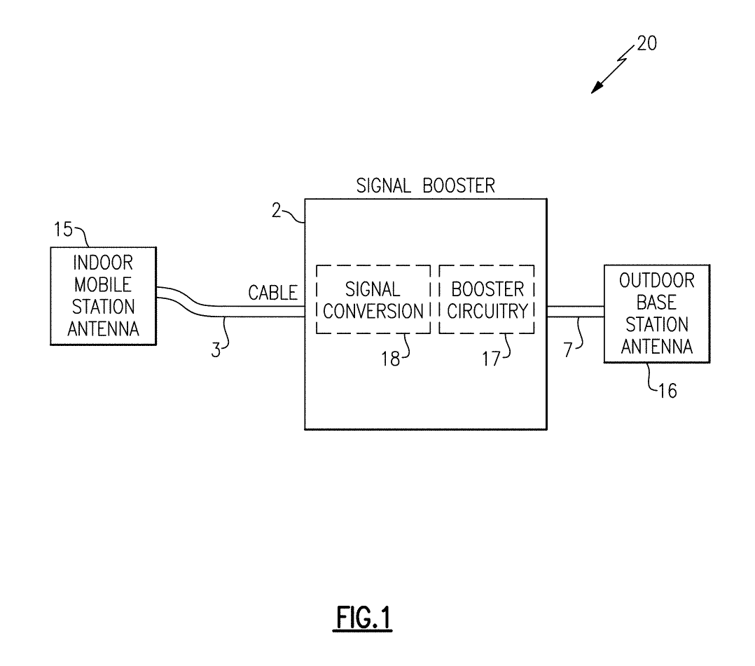

FIG. 1 is a schematic diagram of a signal booster system 20 according to one embodiment. The signal booster system 20 includes a signal booster 2, a cable 3, a cable 7, an indoor mobile station antenna 15, and an outdoor base station antenna 16. The signal booster 2 includes booster circuitry 17 and a signal conversion circuit 18.

In the illustrated embodiment, the outdoor base station antenna 16 is separate from the signal booster 2, for instance, connected via the short cable 7. In one embodiment the short cable 7 has a length of less than about 5 feet, and more particularly, less than about 20 cm. In another embodiment, the short cable 7 provides a loss of less than 1 dB at the highest frequency of interest of the booster circuitry 17.

Although an example with the short cable 7 is shown, the teachings herein are also applicable to configurations in which the outdoor base station antenna 16 is integrated with the signal booster 2. In one example, the outdoor base station antenna 16 can be integrated inside of a housing of the signal booster 2 and/or extend therefrom. In another example, both an integrated base station antenna and external base station antenna are included. In such an implementation, multiple base station antennas can be used for communications or a particular base station antenna can be selected for communications at a given time.

Using the signal booster 2 can provide a number of advantages relative to a configuration in which a long cable connects a signal booster to a base station antenna. For example, a long cable connecting an indoor signal booster and an outdoor base station antenna has loss that degrades transmit power and/or receiver sensitivity. For example, on the transmit side the cable loss can be present between an output of a power amplifier (PA) of the signal booster and the base station antenna, and thus can reduce the strength of transmitted signals and correspondingly degrade the range of communication of the signal booster system. Furthermore, on the receive side the cable loss can be present between the base station antenna and an input of a low noise amplifier (LNA) of the signal booster, and thus can reduce the strength of received signals and correspondingly degrade signal-to-noise ratio (SNR) and receiver sensitivity.

In contrast, in the illustrated embodiment the signal booster 2 is proximately located to the outdoor base station antenna 16, which allows the components to be connected with low loss.

The booster circuitry 17 provides amplification to RF signals associated with one or more uplink and downlink channels. The booster circuitry 17 can include a wide variety of circuitry and/or components. Examples of circuitry and components of the booster circuitry 17 include, but are not limited to, amplifiers (for instance, low noise amplifiers (LNA), power amplifiers (PAs), variable gain amplifiers (VGAs), programmable gain amplifiers (PGAs), and/or other amplification circuits), filters (for instance, surface acoustic wave (SAW) filters, bulk acoustic wave (BAW) filters, film bulk acoustic resonator (FBAR) filters, active circuit filters, passive circuit filters, and/or other filtering structures), duplexers, circulators, frequency multiplexers (for instance, diplexers, triplexers, or other multiplexing structures), switches, impedance matching circuitry, attenuators (for instance, digital-controlled attenuators such as digital step attenuators (DSAs) and/or analog-controlled attenuators such as voltage variable attenuators), detectors, monitors, couplers, and/or control circuitry.

The signal booster 2 is connected to the indoor mobile station antenna 15 via the cable 3. High frequency RF signals can suffer from relatively high cable loss even when the cable length is relatively short.

To mitigate the impact of cable attenuation or loss, the signal booster 2 includes the signal conversion circuit 18 for providing signal conversion such that RF signals provided to and received from the indoor mobile station antenna 15 via the cable 3 are of lower frequency relative to RF signals provided to and received from the outdoor base station antenna 16.

By including the signal conversion circuit 18 in the signal booster 2, communications between the signal booster 2 and the indoor mobile station antenna 15 are achieved with lower signal loss. Thus, mobile devices indoors can realize superior cellular signal strength even in applications in which the base stations of the cellular network transmit and receive RF signals of 6 GHz or more, such as millimeter wave signals.

By using the signal conversion circuit 18, the frequency of RF signals communicated over the cable 3 is reduced, thereby decreasing the amount of loss associated with communications between the signal booster 2 and the indoor mobile station antenna 15. Thus, the signal conversion circuit 18 operates to convert uplink and downlink signals communicated with the base station via the base station antenna 16 to signals of lower frequency for communication to the indoor mobile station antenna 15 via the cable 3.

Accordingly, the signal booster system 20 can be used to improve signal strength of mobile devices within a building, even in applications associated with 5G and/or other high frequency mobile networks. The signal booster system 20 also improves signal-to-noise ratio (SNR) of the mobile devices, thereby permitting mobile devices to transmit at a lower power level to extend battery life. For example, higher SNR can be realized by using superior antennas, receivers, transmitters, and/or other components relative to those used in typical mobile phones, for instance, due to relaxed size and/or power constraints.

In one embodiment, the outdoor base station antenna 16 wirelessly receives an incoming downlink signal from one or more base stations and wirelessly transmits a boosted outgoing uplink signal to the one or more base stations. Additionally, the booster circuit 17 amplifies one or more downlink channels of the incoming downlink signal to generate a boosted incoming downlink signal, which is converted by the signal conversion circuit 18 to generate an outgoing downlink signal that is wirelessly transmitted via the indoor mobile station antenna 15 to one or more mobile devices. Additionally, the indoor mobile station antenna 11 wirelessly receives an incoming uplink signal from the one or more mobile devices, which is converted by the signal conversion circuit 18 to generate an outgoing uplink signal. Additionally, the booster circuit 17 amplifies one or more uplink channels of the outgoing uplink signal to generate the boosted outgoing uplink signal that is wirelessly transmitted by the outdoor base station antenna 16.

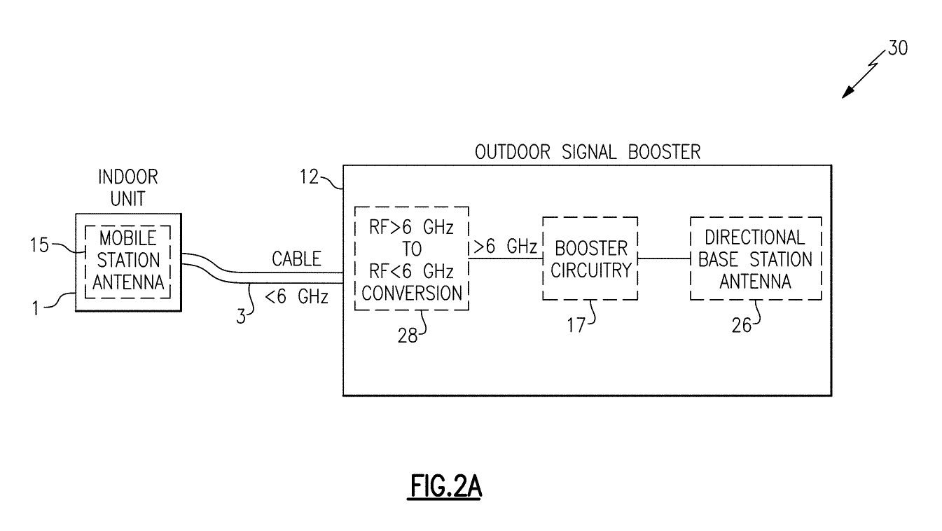

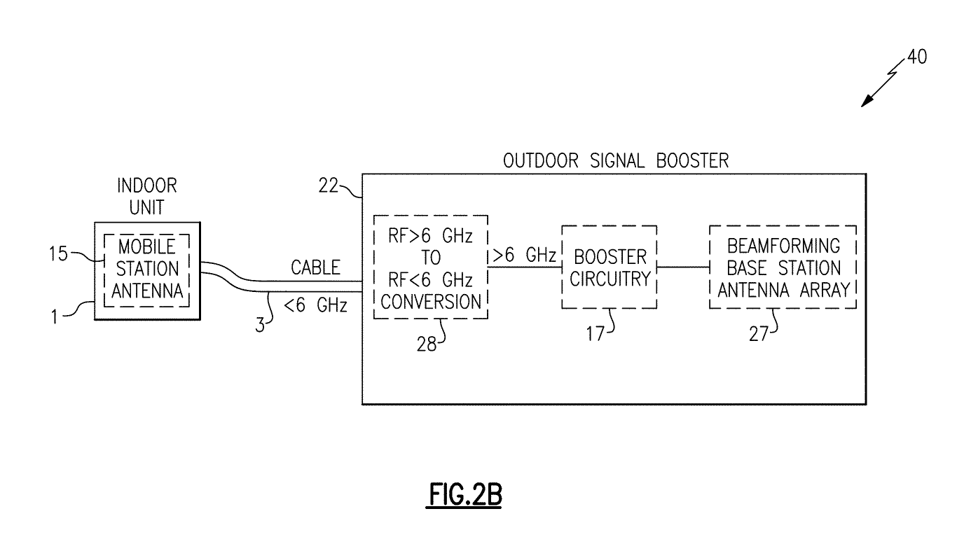

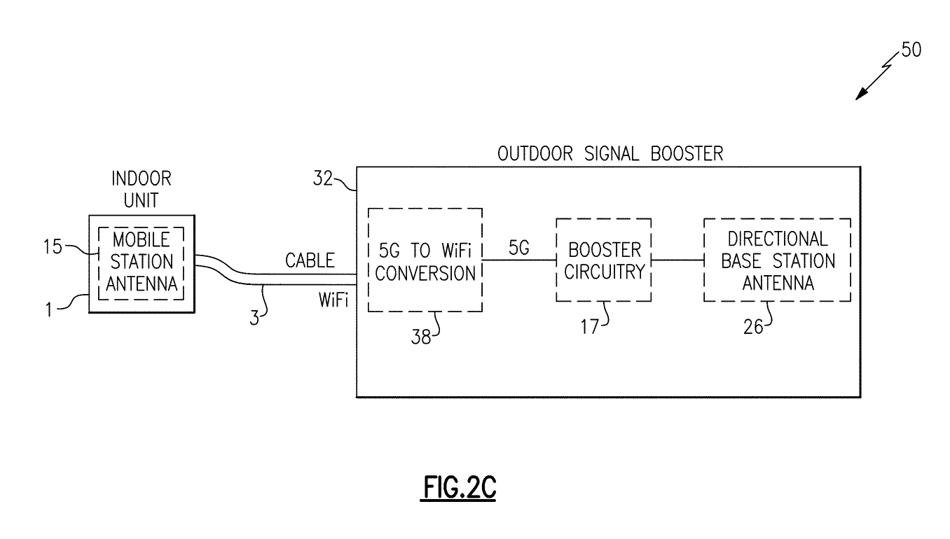

FIG. 2A is a schematic diagram of a signal booster system 30 according to another embodiment. The signal booster system 30 includes an indoor unit 1, a cable 3, and an outdoor signal booster 12. In the illustrated embodiment, the indoor unit 1 includes an integrated mobile station antenna 15. The indoor unit 1 is also referred to herein as a unit. Additionally, the outdoor signal booster 12 includes booster circuitry 17, a directional base station antenna 26, and a signal conversion circuit 28.

The illustrated signal booster system 30 advantageously integrates the directional base station antenna 26 with the outdoor signal booster 12. Thus, the signal booster system 30 operates with enhanced transmit power and/or receiver sensitivity. Accordingly, the signal booster system 30 can communicate with base stations at further distances and/or in harsher radio environments. Furthermore, enhanced transmit power and receiver sensitivity also leads to higher SNR and a corresponding improvement in the quality, speed, and/or reliability of communications.

In certain configurations, the directional base station antenna 26 extends from a housing of the outdoor signal booster 12 and/or is integrated inside of the booster's housing. Although a single base station antenna is illustrated, the teachings herein are applicable to configurations using multiple base station antennas.

With continuing reference to FIG. 2A, the mobile station antenna 15 is integrated with the indoor unit 1, in this embodiment. In certain configurations, the mobile station antenna 15 is inside a housing of the indoor unit 1. However, other implementations are possible, such as configurations in which the mobile station antenna 15 extends from the housing of the indoor unit 1 or configurations in which the indoor unit is omitted in favor of a standalone indoor mobile station antenna. Although a single mobile station antenna 15 is illustrated, the teachings herein are applicable to configurations using multiple mobile station antennas.

The indoor unit 1 can be placed in any suitable location in an interior of the building. In one example, the indoor unit 1 can be set on a table top, windowsill, floor, or other suitable location. In another example, the indoor unit 1 is mountable or otherwise attachable to a wall, ceiling, or other suitable location indoors.

Accordingly, the outdoor signal booster 12 with directional base station antenna 16 can be placed outdoors and isolated from the mobile station antenna 15 within the building. The isolation can be provided at least in part by the building. Furthermore, in certain implementations explicit isolation structures can be included in the outdoor signal booster 12 and/or indoor unit 1 to further enhance antenna-to-antenna isolation and inhibit unintended oscillation of the signal booster system 30.

In the illustrated embodiment, the signal conversion circuit 28 provides conversion between RF signals over 6 GHz and RF signals of less than 6 GHz. Thus, RF signals provided to or received by the base station antenna that are over 6 GHz are converted by the signal conversion circuit 28 to be less than 6 GHz. Thus, signal loss associated with transmitting and received high frequency RF signals over the cable 3 is thereby reduced.

FIG. 2B is a schematic diagram of a signal booster system 40 according to another embodiment. The signal booster system 40 of FIG. 2B is similar to the signal booster system 30 of FIG. 2A, except that the signal booster system 40 of FIG. 2B includes an outdoor signal booster 22 with a different implementation of a base station antenna. In particular, in contrast to the outdoor signal booster 12 of FIG. 2A that includes the directional base station antenna 26, the outdoor signal booster 22 of FIG. 2B includes a beamforming base station antenna array 27.

Using beamforming for communications with a base station can aid in providing enhanced directivity to overcome path losses associated with high frequency radio waves, such as those used in 5G communications.

FIG. 2C is a schematic diagram of a signal booster system 50 according to another embodiment. The signal booster system 50 of FIG. 2C is similar to the signal booster system 30 of FIG. 2A, except that the signal booster system 50 includes a signal conversion circuit 38 that provides 5G to WiFi signal conversion. The signal conversion circuit 38 is also referred to herein as a 5G/WiFi modem.

The signal booster system 50 illustrates one example of a signal booster system that provides signal conversion between a high frequency licensed cellular signal, such as a 5G cellular signal, and a lower frequency unlicensed signal, such as a WiFi signal. The WiFi signal can be, for example, a low band WiFi signal in the 2 GHz band and/or a high band WiFi signal in the 5 GHz band.

By implementing the signal booster system 50 in this manner, mobile devices inside of the building can communicate with the indoor mobile station antenna 15 via WiFi signaling, while the outdoor signal booster 32 can communicate with base stations of the cellular network using 5G technology, including, but not limited to, 5G millimeter wave communications.

FIG. 2D is a schematic diagram of a signal booster system 60 according to another embodiment. The signal booster system 60 of FIG. 2D is similar to the signal booster system 40 of FIG. 2B, except that the signal booster system 60 includes a signal conversion circuit 38 that provides 5G to WiFi signal conversion.

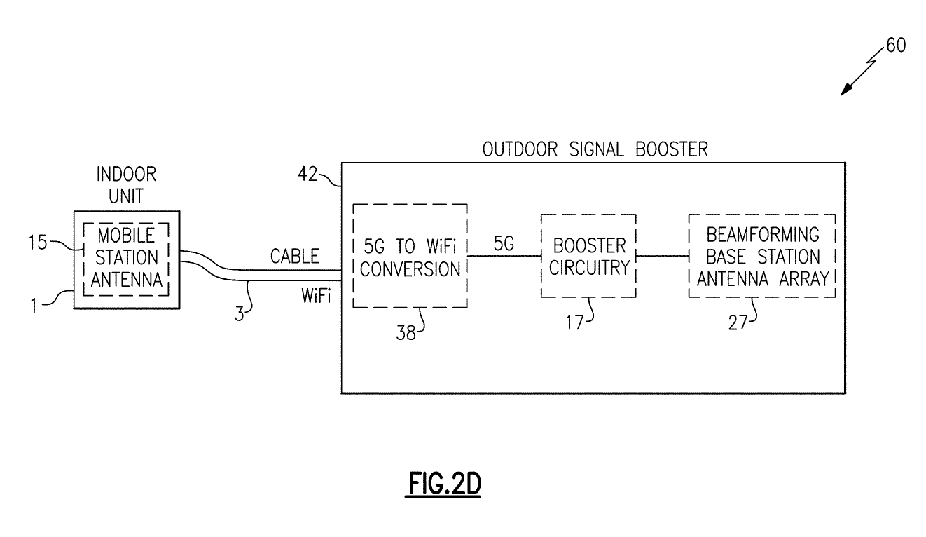

FIG. 3 is a schematic diagram of a signal booster system 70 according to another embodiment. The signal booster system 70 includes a power cable 5, an indoor unit 11, a shared DC power and RF cable 13, and an outdoor signal booster 52. In the illustrated embodiment, the indoor unit 11 includes an integrated mobile station antenna 15 and a DC/RF combiner 53. Additionally, the outdoor signal booster 52 includes a base station antenna 16, booster circuitry 17, a signal conversion circuit 18, and a DC/RF separator 54.

In the illustrated embodiment, the indoor unit 11 receives power from a building power source (for instance, an electrical outlet) via the power cable 5. In one example, a power adapter of the power cable 5 provides AC to DC conversion to provide the indoor unit 11 with DC power. In another example, AC to DC conversion is provided by circuitry in the indoor unit 11.

The indoor unit 11 provides a DC supply voltage to the outdoor signal booster 52 via the shared DC power and RF cable 13, in this embodiment. For example, the DC/RF combiner 53 includes circuitry for combining a DC power supply and an RF signal, while providing isolation. Thus, the indoor unit 11 can combine a DC supply voltage generated from a building power source with RF signals associated with communications of the mobile station antenna 15. The RF signals include RF signals transmitted by the mobile station antenna 15 and RF signals received by the mobile station antenna 15. Accordingly, the shared DC power and RF cable 13 can operate bi-directionally with respect to RF signaling.

In certain implementations, the shared DC power and RF cable 13 includes a conductor that carries an RF voltage that is superimposed on a DC supply voltage. Implementing a signal booster system with a shared DC power and RF cable can provide a number of advantages, such as reduced cabling cost, reduced connectors/connections, improved reliability, and/or enhanced integration. However, other implementations are possible. For example, in another embodiment, a separate power cable (DC and/or AC) is provided directly to the outdoor signal booster 52. In yet another embodiment, separate power and RF cables are bundled as a complex cable.

The outdoor signal booster 52 of FIG. 3 includes the DC/RF separator 54, which can provide filtering and/or other extraction of a DC supply voltage from the shared DC power and RF cable 13. The DC supply voltage is used to power circuitry of the outdoor signal booster, such as the booster circuitry 17 and/or the signal conversion circuit 18. The DC/RF separator 54 can include isolation circuitry (for instance, filters and/or other isolators) for isolating RF circuitry used for signal boosting from DC supply noise and separation circuitry for separating RF and DC.

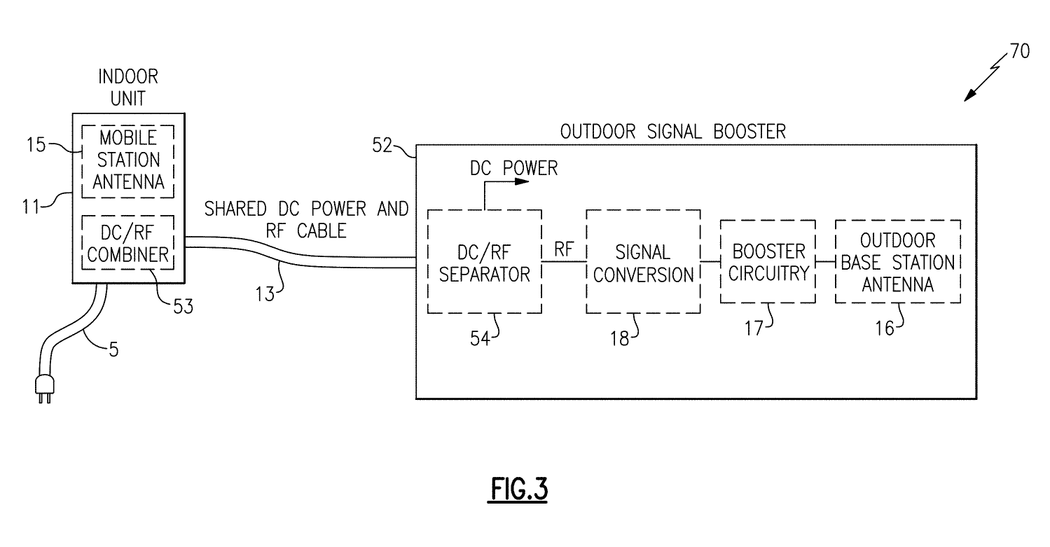

FIG. 4 is a schematic diagram of a mobile network 100 according to one embodiment. The mobile network 100 includes a signal booster system 90, a base station 99, and mobile devices 96a-96c (three shown, in this example). The signal booster system 90 includes an indoor unit 91, an outdoor signal booster 92, a power and RF cable 93, and a power cable 95. For clarity of the figures, internal circuitry and components of the indoor unit 91 and the outdoor signal booster 92 are not shown in FIG. 4.

The signal booster system 90 is implemented in accordance with one or more of the features as described herein. For example, the indoor unit 91 and/or the outdoor signal booster 92 can include one or more features described above with respect to the signal booster systems of FIGS. 1-3.

In the illustrated embodiment, the outdoor signal booster 92 including an integrated base station antenna, booster circuitry, and a signal conversion circuit is mounted on a wall 98 of a building 97. The outdoor signal booster 92 can be attached to the wall 98 in a wide variety of ways, such as by using a wide variety of mounts and/or fasteners (for example, mount/fastener 94). Although FIG. 4 illustrates an example in which the outdoor signal booster 92 is attached to a wall, the teachings are applicable to configuration in which an outdoor signal booster is attached to other surfaces of a building, including, but not limited to, a roof 89.

In one embodiment, the integrated base station antenna of the outdoor signal booster 92 is a directional antenna, such as a Yagi antenna, that is pointed in a direction of a particular base station. In certain implementations, the outdoor signal booster 92 includes a beamforming antenna array.

The illustrated embodiment achieves the advantages of robust communication between the base station 99 and the signal booster's base station antenna while also achieving high transmit power and/or receiver sensitivity relative to an implementation in which an indoor signal booster connects to an outdoor base station antenna via a long cable.

In certain implementations, structures of a building are advantageously used to provide shielding or isolation between the outdoor signal booster's base station antenna and the indoor unit's mobile station antenna. For example, a building's roof and/or walls can serve as a reflector or isolator for providing antenna-to-antenna isolation. In certain implementations, the outdoor signal booster 92 and/or indoor unit 91 can further include an explicit isolator configured to provide additional antenna-to-antenna isolation.

The indoor unit 91 includes an integrated mobile station antenna. The indoor unit 91 can be placed and/or attached to a wide variety of surfaces in the interior of the building 97. In another embodiment, the indoor unit 91 can be omitted in favor of a mobile station antenna that is not integrated with an indoor unit.

In certain implementations, the mobile station antenna of the indoor unit 91 is an omnidirectional or directional antenna configured to primarily radiate within an interior of the building 97. Thus, the mobile station antenna can communicate with mobile devices within the building 97, such as mobile devices 96a-96c.

As shown in FIG. 4, the indoor unit 91 receives power from a building power source (for instance, an AC outlet 88) over the power cable 95. Additionally, the power and RF cable 93 is used both for communicating RF signals between the indoor unit 91 and the outdoor signal booster 92 and for supplying the outdoor signal booster 92 with power. In certain implementations, the indoor unit 91 and/or a power adapter of the power cable 95 provides AC to DC conversion.

The signal booster system 90 can be implemented using any suitable combination of features disclosed herein.

Although the mobile network 100 illustrates an example with three mobile devices and one base station, the mobile network 100 can include base stations and/or mobile devices of other numbers and/or types. For instance, mobile devices can include mobile phones, tablets, laptops, wearable electronics (for instance, smart watches), and/or other types of UE suitable for use in a wireless communication network.

Although an example with a home is shown, a signal booster system can be installed in a variety of types of buildings, such as homes, offices, commercial premises, factories, garages, barns, and/or any other suitable building.

The outdoor signal booster 92 can retransmit signals to and receive signals from the base station 99 using the outdoor signal booster's base station antenna. Additionally, the indoor unit 91 can retransmit signals to and receive signals from the mobile devices 96a-96c using the indoor unit's mobile station antenna. The outdoor signal booster 92 includes a signal conversion circuit that operates to provide signal conversion such that RF signals provided to and received from the indoor mobile station antenna via the cable 93 are of lower frequency relative to RF signals provided to and received from the outdoor base station antenna.

The outdoor signal booster 92 can be used to communicate in a variety of types of networks, including, but not limited to, networks operating using FDD, TDD, or a combination thereof.

As a network environment changes, the outdoor signal booster 92 can communicate with different base stations. Thus, it will be understood that base station 99 represents a particular base station or group of base stations that the signal booster system 90 is in communication with at a particular time.

Thus, although FIG. 4 illustrates the outdoor signal booster 92 as communicating with one base station 99, the outdoor signal booster 92 can communicate with multiple base stations. For example, the outdoor signal booster 92 can be used to communicate with base stations associated with different cells of a network and/or with base stations associated with different networks, such as networks associated with different wireless carriers and/or frequency bands.

In certain implementations, the mobile devices 96a-96c can communicate at least in part over multiple frequency bands, including one or more high frequency cellular bands, including those associated with 5G technologies and other emerging mobile communication technologies.

Although specific examples of frequency bands and communication technologies have been described above, the teachings herein are applicable to a wide range of frequency bands and communications standards. For example, signal boosters can be used to boost a wide variety of bands, including, but not limited to, 2G bands, 3G bands (including 3.5G bands), 4G bands (including 4.5G bands), 5G bands, WiFi bands (for example, according to Institute of Electrical and Electronics Engineers 802.11 wireless communication standards), and/or digital television bands (for example, according to Digital Video Broadcasting, Advanced Television System Committee, Integrated Services Digital Broadcasting, Digital Terrestrial Multimedia Broadcasting, and Digital Multimedia Broadcasting standards).

Accordingly, the signal booster system 90 can be configured to boost signals associated with multiple frequency bands so as to improve network reception for each of the mobile devices 96a-96c. Configuring the signal booster system 90 to service multiple frequency bands can improve network signal strength. For example, the signal booster system 90 can improve network signal strength of devices using the same or different frequency bands, the same or different wireless carriers, and/or the same or different wireless technologies. Configuring the signal booster system 90 as a multi-band booster can avoid the cost of separate signal boosters for each specific frequency band and/or wireless carrier.

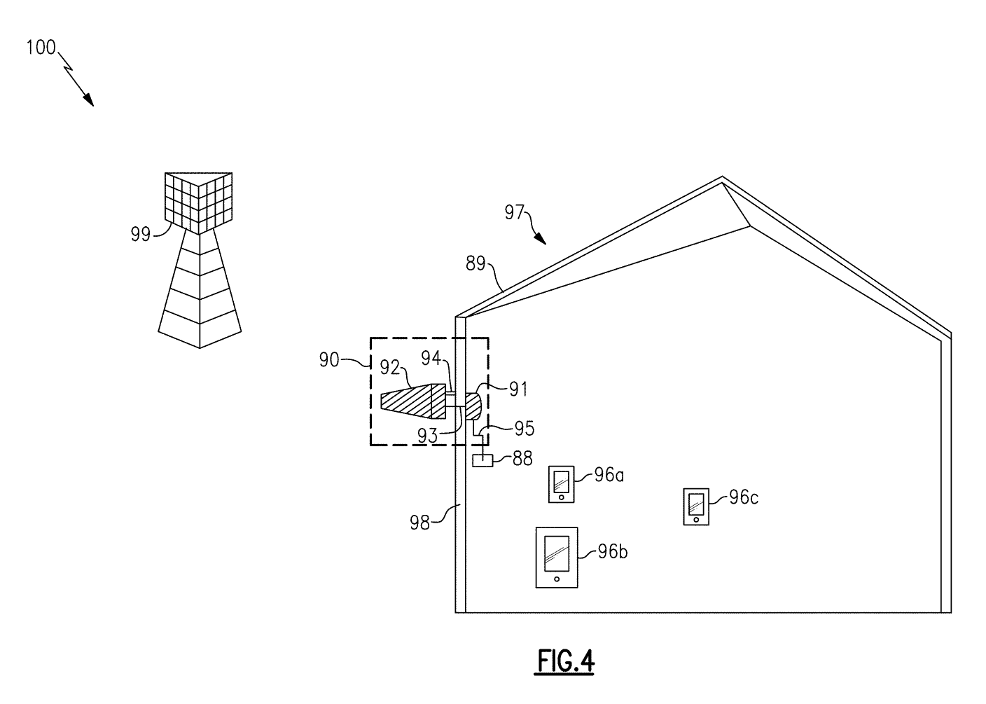

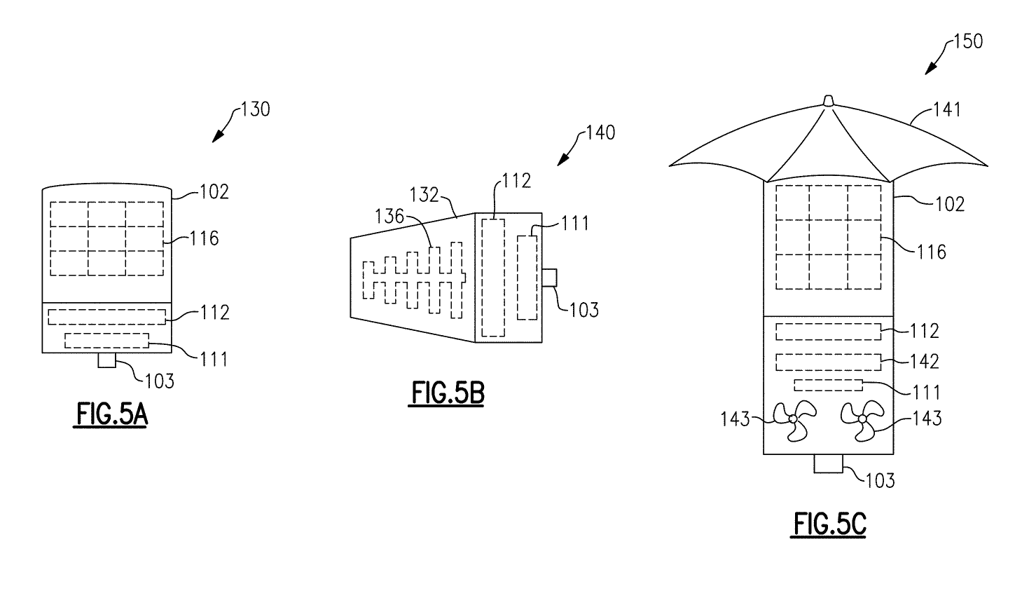

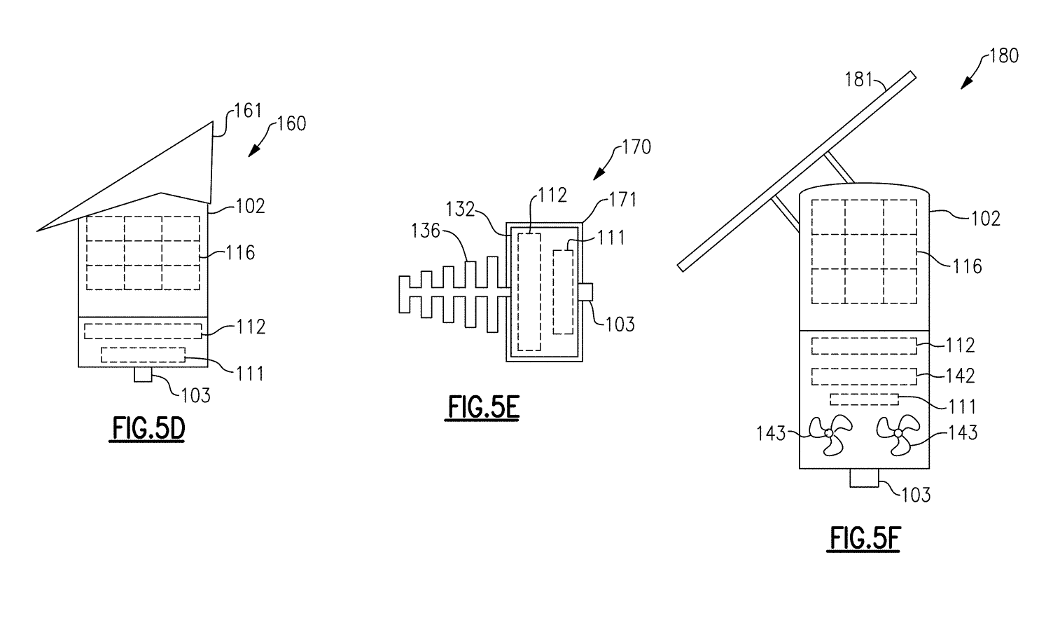

FIG. 5A is a side view of one embodiment of an outdoor signal booster 130. The outdoor signal booster 130 includes a housing 102, a cable port 103, a circuit board 111, an isolator 112, and a base station antenna 116 (a beamforming antenna array, in this example). The outdoor signal booster 130 is securable to a building surface using any suitable mounting and/or fastening structures (not illustrated in FIG. 5A).

The circuit board 111 includes circuitry and electronic components of the outdoor signal booster 130, such as booster circuitry, a signal conversion circuit, a DC/RF separator, a temperature detector, and/or an external antenna detector. In the illustrated embodiment, the base station antenna 116 is within the housing 102 of the outdoor signal booster 130. However, other implementations are possible, such as configurations in which a base station antenna extends from the housing 102 or is separate from the outdoor signal booster 130. Although one implementation of a base station antenna is shown, other implementations of base station antennas can be used in accordance with the teachings herein. Furthermore, multiple base station antennas can be included.

In the illustrated embodiment, the base station antenna 116 is isolated from the circuit board 111 by the isolator or RF shield 112. Implementing an outdoor signal booster in this manner provides robust base station communications while isolating the base station antenna 116 from noise and/or interference of the circuit board 111. In certain implementations, the RF shield 112 can include an enclosure (for instance, a lid) covering at least a portion of the circuit board 111.

The outdoor signal booster 130 can be conveniently installed in a wide range of building surfaces.

The housing 102 is used to house the circuitry of the outdoor signal booster 130. In certain implementations, the housing includes a UV resistant coating or film for heat reduction and/or a seal coating or film for moisture, humidity, and/or corrosion protection.

Although one example of a shape of the housing 102 is shown in FIG. 5A, the housing can have other shapes and/or sizes. The housing 102 can be made of a wide variety of materials, including, but not limited to, plastic and/or a metal, such as stainless steel.

In the illustrated embodiment, the outdoor signal booster 130 includes a cable port 103 that is connectable to a cable. The outdoor signal booster 130 communicates with an indoor unit via the cable. In one example, the cable port 103 receives a shared DC power and RF cable used for carrying RF and DC power. In another example, the cable port 103 receives a complex cable bundling an RF cable and a power cable. In yet another example, the outdoor signal booster 130 is connected to multiple cables, such as an RF cable and a separate power cable (DC and/or AC). In certain implementations, the port 103 is associated with a pluggable cable. In other implementations, the cable is secured to the port 103 to prevent removal.

FIG. 5B is a side view of another embodiment of an outdoor signal booster 140. The outdoor signal booster 140 of FIG. 5B is similar to the outdoor signal booster 130 of FIG. 5A, except that the outdoor signal booster 140 of FIG. 5B includes a Yagi antenna 136 and a housing 132 of a different shape. In certain implementations, an outdoor signal booster includes a directional antenna, such as the Yagi antenna 136.

FIG. 5C is a side view of another embodiment of an outdoor signal booster 150. The outdoor signal booster 150 of FIG. 5C is similar to the outdoor signal booster 130 of FIG. 5A, except that the outdoor signal booster 150 of FIG. 5C further includes an umbrella 151, which can aid in limiting sun exposure to the housing 102, thereby providing protection against heat. Additionally, the outdoor signal booster 150 further includes a heat sink 142 and fans 143 within the housing 102.

Including one or more umbrellas, heat sinks, and/or fans provides an outdoor signal booster with enhanced robustness against overheating. Although one embodiment of a signal booster implemented with overheating protection is shown, a wide variety of overheating protection structures and/or materials can be used. In one example, the outdoor signal booster 150 includes a shell coating, such as a UV coating or other suitable coating for enhancing protection from overheating. In another example, the outdoor signal booster 150 includes at least one of a sun visor or solar reflector (for instance a solar mirror).

FIG. 5D is a side view of another embodiment of an outdoor signal booster 160. The outdoor signal booster 160 of FIG. 5D is similar to the signal booster 130 of FIG. 5A, except that the outdoor signal booster 160 further includes a solar visor or solar hat 161.

FIG. 5E is a side view of another embodiment of an outdoor signal booster 170. The outdoor signal booster 170 includes a housing 132 and a base station antenna 136 extending from the housing 102. The circuit board 111 and RF shield 112 are within the housing 132, which includes a cable port 103 thereon for connecting to a cable. In the illustrated embodiment, a shell coating 171 is included on the housing 132 for heat protection. The shell coating 171 corresponds to a UV coating or other suitable coating for enhancing protection from overheating.

FIG. 5F is a side view of another embodiment of an outdoor signal booster 180. The outdoor signal booster 180 of FIG. 5F is similar to the signal booster 130 of FIG. 5A, except that the outdoor signal booster 180 further includes a solar mirror or solar reflector 181.

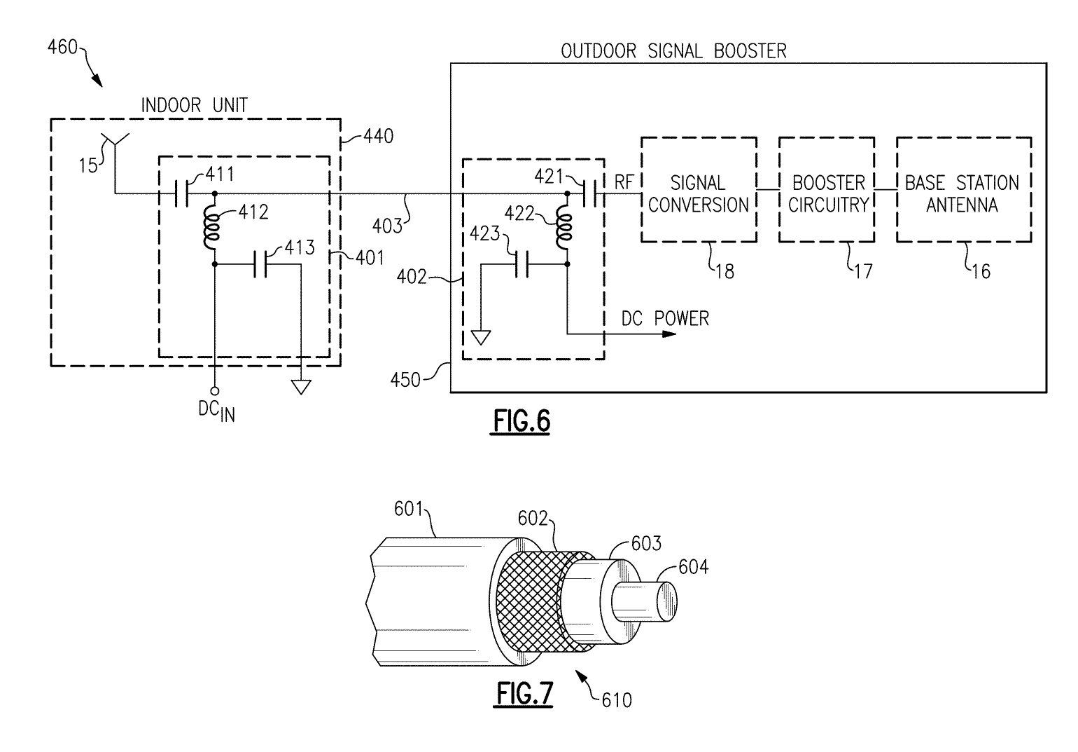

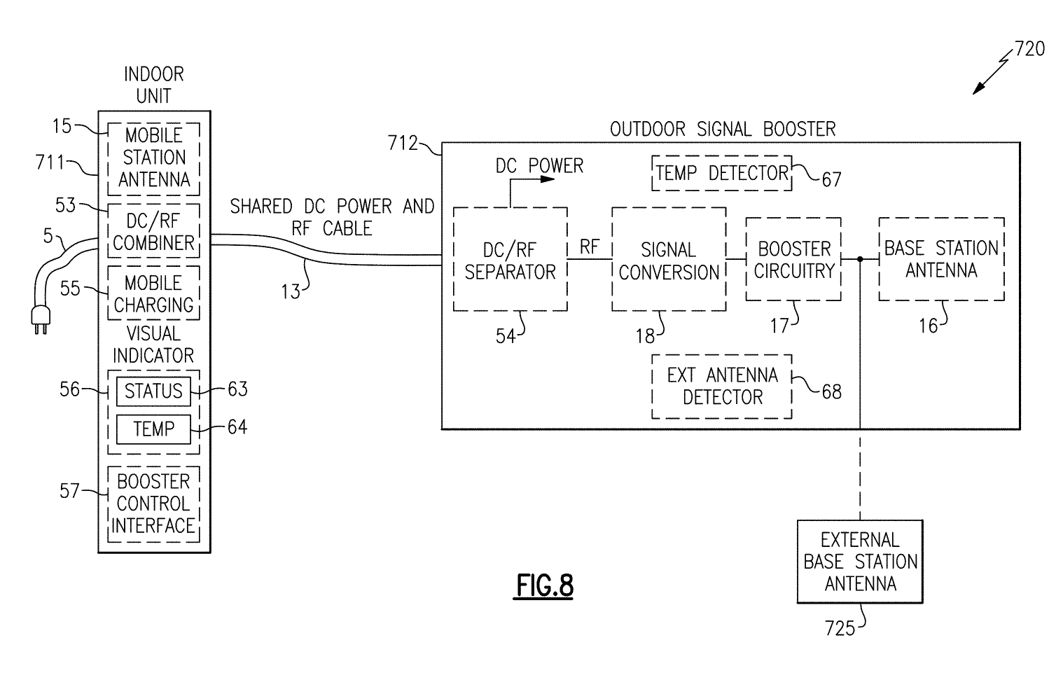

FIG. 6 is a schematic diagram of a signal booster system 460 including circuitry for connecting to a shared DC power and RF cable, according to another embodiment. As shown in FIG. 6, the signal booster system 460 includes a shared DC power and RF cable 403, an indoor unit 440, and an outdoor signal booster 450.

The indoor unit 440 of FIG. 6 is similar to the indoor unit 11 of FIG. 3, except that the indoor unit 410 further illustrates a specific implementation of a DC/RF combiner circuit 401. As shown in FIG. 6, the DC/RF combiner circuit 401 includes a DC blocking capacitor 411, an RF choke inductor 412 and a decoupling capacitor 413. The DC/RF combiner circuit 401 serves to combine a DC input voltage DC_{1N} with an RF signal associated with the mobile station antenna 15 while providing isolation.

The outdoor signal booster 450 of FIG. 6 is similar to the outdoor signal booster 52 of FIG. 3, except that the outdoor signal booster 450 illustrates a specific implementation of a DC/RF separator circuit 402. The DC/RF separator circuit 402 includes a DC blocking capacitor 421, an RF choke inductor 422 and a decoupling capacitor 423.

As shown in FIG. 6, the shared DC power and RF cable 403 carries an RF voltage superimposed on a DC supply voltage. Thus, the shared DC power and RF cable 403 carries DC power provided at the input DC_{1N} to the outdoor signal booster 403 as well as RF signals associated with communications of the mobile station antenna 15. In certain implementations, the input DC_{1N} receives a DC voltage generated from a building's power source.

Although one embodiment of circuitry for connecting to a shared DC power and RF cable is shown, other implementations are possible.

FIG. 7 is a perspective view of one example of a shared DC power and RF cable 610 for a signal booster system. In this example, the shared DC power and RF cable 610 is implemented as a coaxial cable including outside insulation 601, metal mesh conductor 602, interior insulation 603, and metal inner conductor 604.

The outside insulation 601 protects the coaxial cable from external friction, interference, or damage. The metal mesh conductor 602 aids in containing signal leakage from metal inner conductor 604 and also shields the signal transmitted on the metal inner conductor 604 from external electric and/or magnetic fields while serving as ground.

In the illustrated embodiment, the metal mesh conductor 602 carries a ground voltage to an outdoor signal booster, and the metal inner conductor 604 carries an RF voltage superimposed on a DC supply voltage. Thus, a common conductor carries both DC power and RF signals, in this embodiment.

The shared DC power and RF cable 610 illustrates one embodiment of a shared DC power and RF cable that can be used for carrying both RF signals and DC supply voltage to an outdoor signal booster. In another embodiment, a pair of separate cables are physically bundled together (referred to herein as a complex cable) to carry RF and DC power, respectively. However, the teachings herein are application to other implementations of shared DC power and RF cables, as well as to signal booster systems that do not include a shared DC power and RF cable.

FIG. 8 is a schematic diagram of a signal booster system 720 according to another embodiment. The signal booster system 720 includes a power cable 5, a shared DC power and RF cable 13, an indoor unit 711, and an outdoor signal booster 712.

The indoor unit 711 of FIG. 8 is similar to the indoor unit 11 of FIG. 3, except that the indoor unit 711 further includes a mobile charging circuit 55, a visual indicator 56, and a booster control interface 57.

The mobile charging circuit 55 is operable to charge a battery of a user's mobile device. In one example, a charging cable is provided from the indoor unit 711 to the mobile device, and the charging circuit 55 charges the mobile device's battery via the charging cable. In another example, a mobile device can be coupled to the indoor unit 711 and the mobile charging circuit 55 provides wireless charging.

The visual indicator 56 can include one or more displays, lights, or other visual indicators to alert a user to the status of operation of the signal booster system 720. In one embodiment, the visual indicator 56 includes at least one of a light or a display. For instance, the visual indicator 56 can include a light-emitting diode (LED) and/or a liquid crystal display (LCD).

In the illustrated embodiment, the visual indicator 56 includes a status indicator 63 and a temperature indicator 64. Although one example of visual indicators is shown, an indoor unit can be configured to display other types of information related to the operation of the signal booster system 720. The status indicator 63 indicates the status of the outdoor signal booster 720, including, but not limited to, whether the outdoor signal booster is powered, whether boosting is active for one or more bands, antenna status, and/or whether oscillation/pre-oscillation has occurred. The temperature indicator 64 indicates a temperature of the outdoor signal booster 712 as detected by the signal booster's temperature detector and/or whether the signal booster is operating with backed-off performance because of high temperature. In one embodiment, a temperature alarm is alerted when a high temperature condition is present.

The booster control interface 57 can be used to control the outdoor signal booster 712 in a wide variety of ways. Examples of types of control provided by the booster control interface 57 include, but are not limited to, remote shut-down or power control, remote control of gain and/or attenuation (including, for example, band specific control), and/or remote control of antenna selection (for instance, in multi-antenna configurations). Including the booster control interface 57 allows a user indoors to control the outdoor signal booster 712 without needing to be physically present at the outdoor signal booster 712, which may be attached to a roof or wall that is inconvenient for the user to access.

The outdoor signal booster 712 of FIG. 8 is similar to the outdoor signal booster 52 of FIG. 3, except that the outdoor signal booster 712 further includes a temperature detector 67 and an external antenna detector 68.

The temperature detector 67 detects the temperature of the outdoor signal booster 712. In one embodiment, when a high temperature condition is detected (for instance, a temperature of about 120 degrees Fahrenheit or higher), the outdoor signal booster 712 automatically adjusts performance (for instance, decreases gain) to protect from overheating. Such backed-off performance can be communicated to the user via the visual indicator 56.

The external antenna detector 68 detects whether or not an external base station antenna 725 has been connected to the outdoor signal booster. In one embodiment, when the external antenna detector 68 detects the external base station antenna 725 is connected, the external antenna detector 68 disables the integrated base station antenna 16 in favor of using the external base station antenna 725 for communications. When an external base station antenna 725 is present, the outdoor signal booster 712 can detect output power of the antenna (for instance, via power detectors and/or directional couplers) to ensure that output power does not exceed FCC EIRP limits and/or other emissions regulations or specifications.

In certain embodiments herein, a signal booster system includes an outdoor base station antenna for communicating with base stations of a cellular network, and an indoor mobile station antenna for communicating with UE of the cellular network, such as mobile phones. The signal booster system further includes an indoor unit that wirelessly communicates via the indoor mobile station antenna and a signal booster that wirelessly communicates via the outdoor base station antenna and that is coupled to the indoor unit via a cable. In certain implementations, the indoor mobile station antenna is integrated with the indoor unit and/or the outdoor base station antenna is integrated with the signal booster. The signal booster includes booster circuitry for providing amplification to RF signals associated with one or more uplink and downlink channels of the cellular network. The signal booster further includes a first signal conversion circuit operable to provide signal conversion such that RF signals provided to and/or received from the indoor unit via the cable are of lower frequency relative to RF signals communicated via the outdoor base station antenna. The indoor unit further includes a second signal conversion circuit operable to provide signal conversion such that RF signals received from and/or provided to the signal booster via the cable are of lower frequency relative to RF signals communicated via the indoor mobile station antenna.

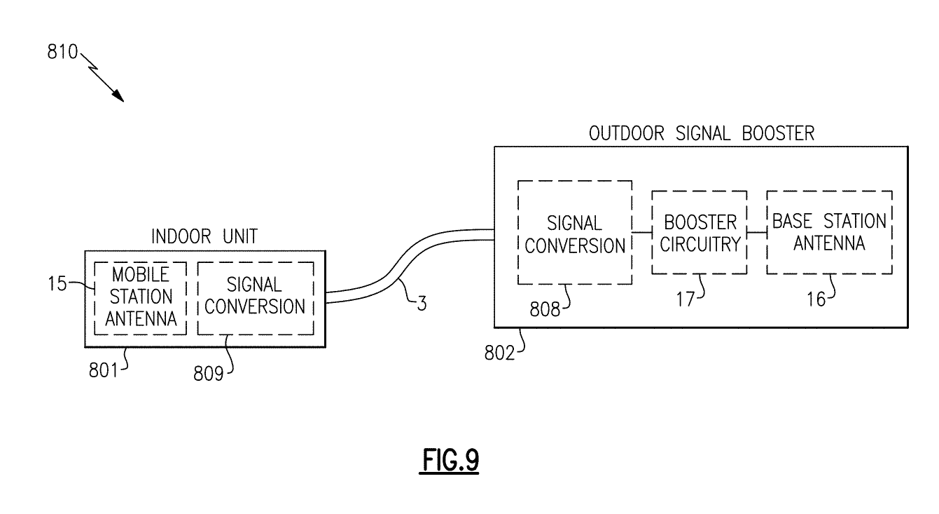

FIG. 9 is a schematic diagram of a signal booster system 810 according to another embodiment. The signal booster system 810 includes a cable 3, an indoor unit 801, and an outdoor signal booster 802. The outdoor signal booster 802 includes a base station antenna 16, booster circuitry 17, and a first signal conversion circuit 808. Additionally, the indoor unit 801 includes a mobile station antenna 15 and a second signal conversion circuit 809.

Although the signal booster system 810 illustrates an embodiment in which the base station antenna 16 is integrated into the outdoor signal booster 802, the teachings herein are also applicable to configurations in which a base station antenna is not integrated into a signal booster. Additionally, although the signal booster system 810 illustrates an embodiment in which the mobile station antenna 15 is integrated into the indoor unit 801, the teachings herein are also applicable to configurations in which a mobile station antenna is not integrated into an indoor unit.

The first signal conversion circuit 808 is operable to provide signal conversion such that RF signals provided to and/or received from the indoor unit 801 via the cable 3 are of lower frequency relative to RF signals communicated via the outdoor base station antenna 16. Additionally, the second signal conversion circuit 809 is operable to provide signal conversion such that RF signals received from and/or provided to the signal booster 802 via the cable 3 are of lower frequency relative to RF signals communicated via the indoor mobile station antenna 15.

By implementing the signal booster system 810 in this manner, signal loss associated with transmitting and/or received high frequency RF signals over an RF cable is reduced or avoided.

In one embodiment, the base station antenna 16 receives an incoming downlink signal from one or more base stations of a cellular network. Additionally, the booster circuitry 17 boosts one or more downlink channels of the incoming downlink signal to generate a boosted incoming downlink signal, which the first signal conversion circuit 808 processes to generate a converted downlink signal of lower frequency than the incoming downlink signal. Additionally, the second signal conversion circuit 809 processes the converted downlink signal to generate an outgoing downlink signal that is wirelessly transmitted via the mobile station antenna 801 to one or more mobile devices. In certain implementations, the signal conversion circuits 808, 809 provide complementary conversion operations such that the indoor unit 801 recovers a boosted version of the incoming downlink signal.

In one embodiment, the mobile station antenna 15 receives an incoming uplink signal from one or more mobile devices of the cellular network. Additionally, the second signal conversion circuit 809 processes the incoming uplink signal to generate a converted uplink signal of lower frequency than the incoming uplink signal. Additionally, the first signal conversion circuit 808 processes the converted uplink signal to generate an outgoing uplink signal, which is boosted by the booster circuit 17 and wirelessly transmitted via the base station antenna 16. In certain implementations, the signal conversion circuits 808, 809 operate in a complementary manner such that the signal booster 802 recovers a boosted version of the incoming uplink signal.

Accordingly, the first and second signal conversion circuit 808, 809 can be used to provide conversion to uplink and/or downlink signals of a cellular network.

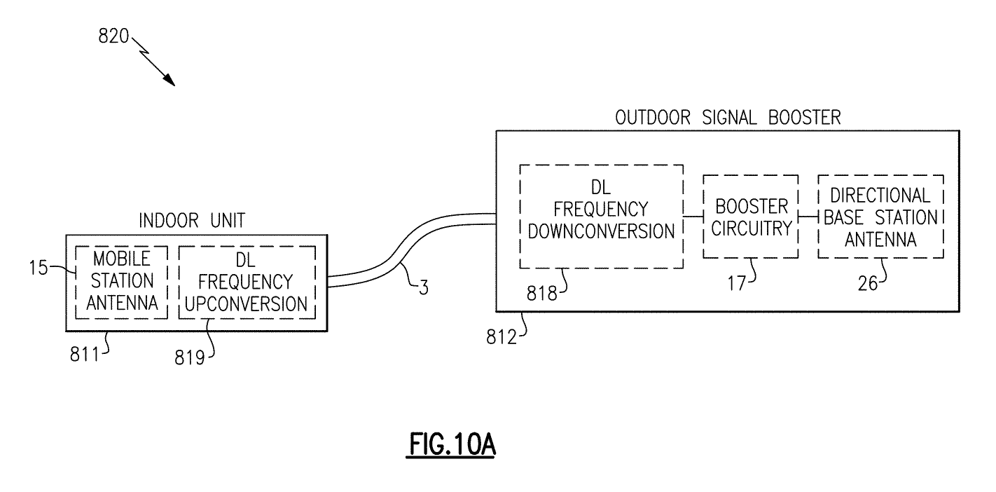

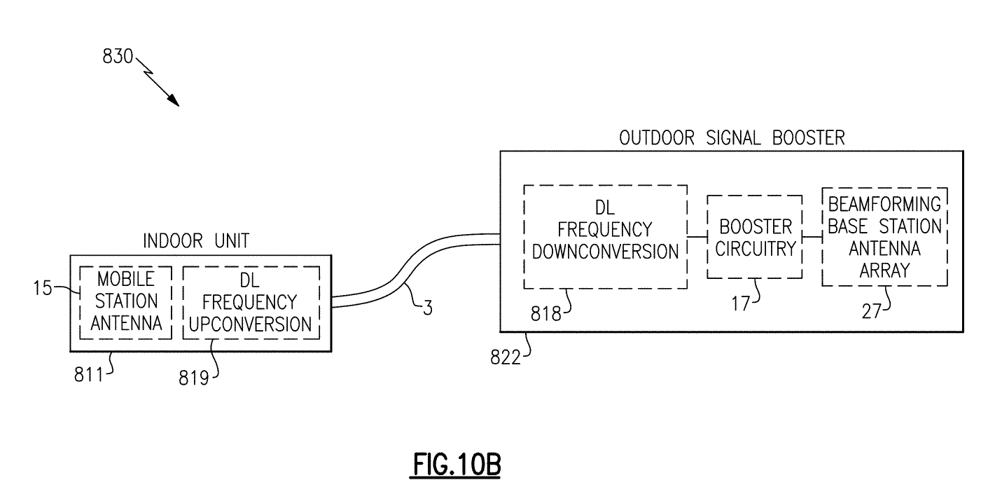

FIG. 10A is a schematic diagram of a signal booster system 820 according to another embodiment. The signal booster system 820 includes a cable 3, an indoor unit 811, and an outdoor signal booster 812.

The outdoor signal booster 812 of FIG. 10A is similar to the outdoor signal booster 802 of FIG. 9, except that the outdoor signal booster 812 includes a downlink frequency downconversion circuit 818, which corresponds to one embodiment of the first signal conversion circuit 808 of FIG. 9.

The indoor unit 811 of FIG. 10A is similar to the indoor unit 801 of FIG. 9 except that the indoor unit 811 of FIG. 10 includes a downlink frequency upconversion circuit 819, which corresponds to one embodiment of the second signal conversion circuit 809 of FIG. 9. The indoor unit 801 also includes a directional base station antenna 26, which corresponds to one embodiment of the base station antenna 16 of FIG. 9.

The downlink frequency downconversion circuit 818 operates to downconvert or downshift the frequency content of a boosted downlink signal from the booster circuitry 17 to generate a downconverted downlink signal that is sent over the cable 3 to the indoor unit 811. The downlink frequency upconversion circuit 819 operates to upconvert or upshift the frequency content of the downconverted downlink signal to generate a mobile device downlink signal that is wirelessly transmitted to one or more mobile devices via the mobile station antenna 15. In certain implementations, the downlink frequency downconversion circuit 818 and the downlink frequency upconversion circuit 819 provide substantially equal amounts of frequency shifting.

Since signal loss over the cable 3 increases at high frequency, downconverting the downlink signal for transmission over the cable 3 reduces signal loss. Additionally, the received downconverted downlink signal is upconverted to thereby recover the downlink signal at the indoor unit.

Although the signal booster system 820 illustrates a configuration in which signal conversion is provided to downlink signals, the teachings herein are also applicable to signal booster systems that provide signal conversion to uplink signals or to both downlink and uplink signals.

FIG. 10B is a schematic diagram of a signal booster system 830 according to another embodiment. The signal booster system 830 includes a cable 3, an indoor unit 811, and an outdoor signal booster 822.

The signal booster system 830 of FIG. 10B is similar to the signal booster system 820 of FIG. 10A, except that the signal booster system 830 includes a signal booster implemented with a different configuration of a base station antenna. In particular, the outdoor signal booster 822 of FIG. 10B includes a beamforming base station antenna array 27.

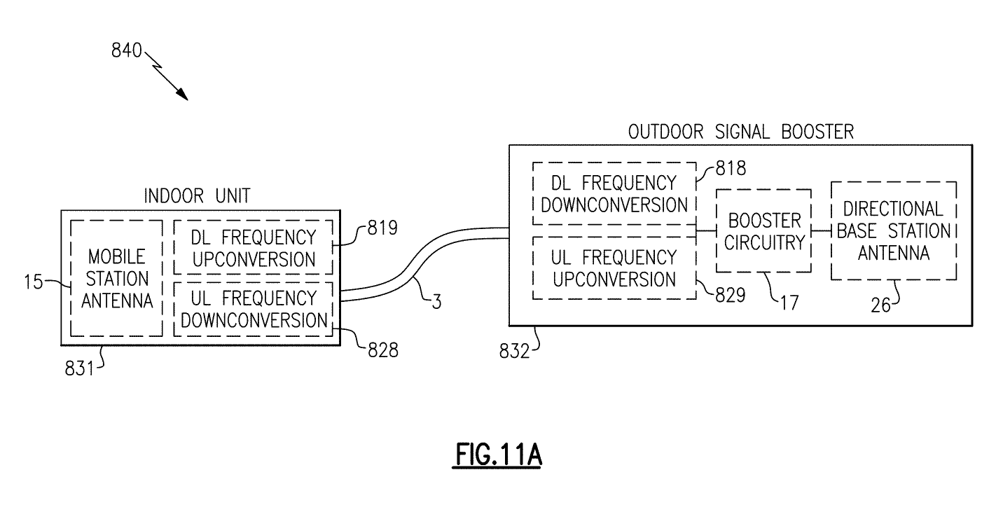

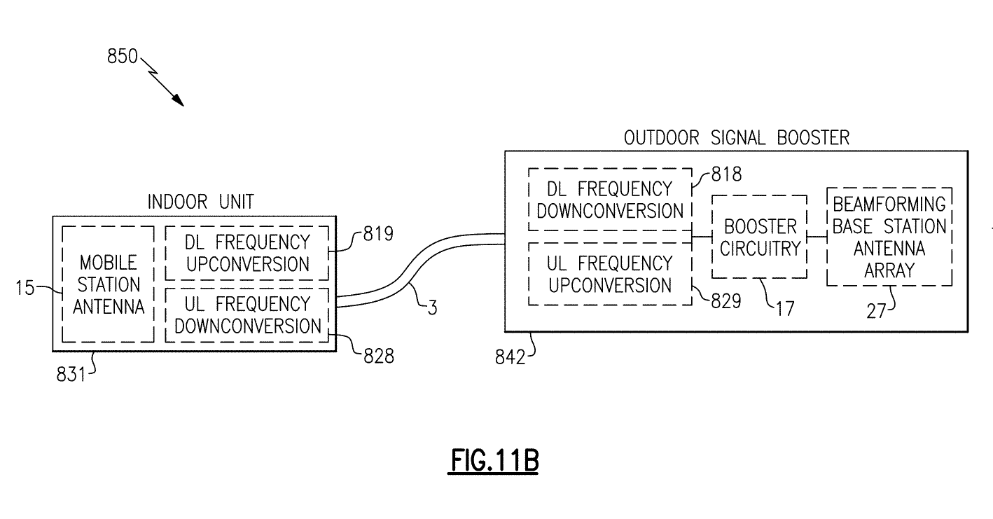

FIG. 11A is a schematic diagram of a signal booster system 840 according to another embodiment. The signal booster system 840 includes a cable 3, an indoor unit 831, and an outdoor signal booster 842.

The indoor unit 831 of FIG. 11A is similar to the indoor unit 811 of FIG. 10A, except that the indoor unit 831 of FIG. 11A further includes an uplink frequency downconversion circuit 828. The uplink frequency downconversion circuit 828 operates to downconvert an uplink signal wirelessly received by the mobile station antenna 15 to generate a downconverted uplink signal that is transmitted to the outdoor signal booster 832 via the cable 3.

The outdoor signal booster 832 of FIG. 11B is similar to the outdoor signal booster 812 of FIG. 10A, except that the outdoor signal booster 832 further includes the uplink frequency upconversion circuit 829. The uplink frequency upconversion circuit 829 operates to upconvert the downconverted uplink signal received from the cable 3 to thereby recover the uplink signal. The uplink signal is thereafter boosted by the booster circuitry 17 and wirelessly transmitted to one or more base stations via the directional base station antenna 26.

The signal booster system 840 of FIG. 11A illustrates one embodiment of a signal booster system that provides frequency upconversion and downconversion to both uplink and downlink signals. Thus, both uplink signals and downlink signals obtain the benefits of being sent over the cable 3 at decreased frequency and thus lower loss.

FIG. 11B is a schematic diagram of a signal booster system 850 according to another embodiment. The signal booster system 850 of FIG. 11B is similar to the signal booster system 840 of FIG. 11A, except that the signal booster system 850 includes a signal booster implemented with a different configuration of a base station antenna. In particular, the outdoor signal booster 842 of FIG. 11B includes a beamforming base station antenna array 27.

FIG. 12 is a schematic diagram of a signal booster system 860 according to another embodiment. The signal booster system 860 includes a power cable 5, a shared DC power and RF cable 13, an indoor unit 851 and an outdoor signal booster 852.

As shown in FIG. 12, the outdoor signal booster 852 includes a base station antenna 16, booster circuitry 17, a DC/RF separator 54, a temperature detector 67, an external antenna detector 68 (for detecting whether or not an external base station antenna 725 is present), and a first signal conversion circuit 808. Additionally, the indoor unit 851 includes a housing 841, a mobile station antenna 15, a DC/RF combiner 53, a mobile charging circuit 55, a visual indicator 56, a booster control interface 57, and a second signal conversion circuit 809. In this embodiment, the mobile station antenna 15 is within the housing 841. However, other implementations are possible, such as configurations in which a mobile station antenna 722 is additionally or alternatively included, and extends from the housing 841 and/or is pluggable therein.

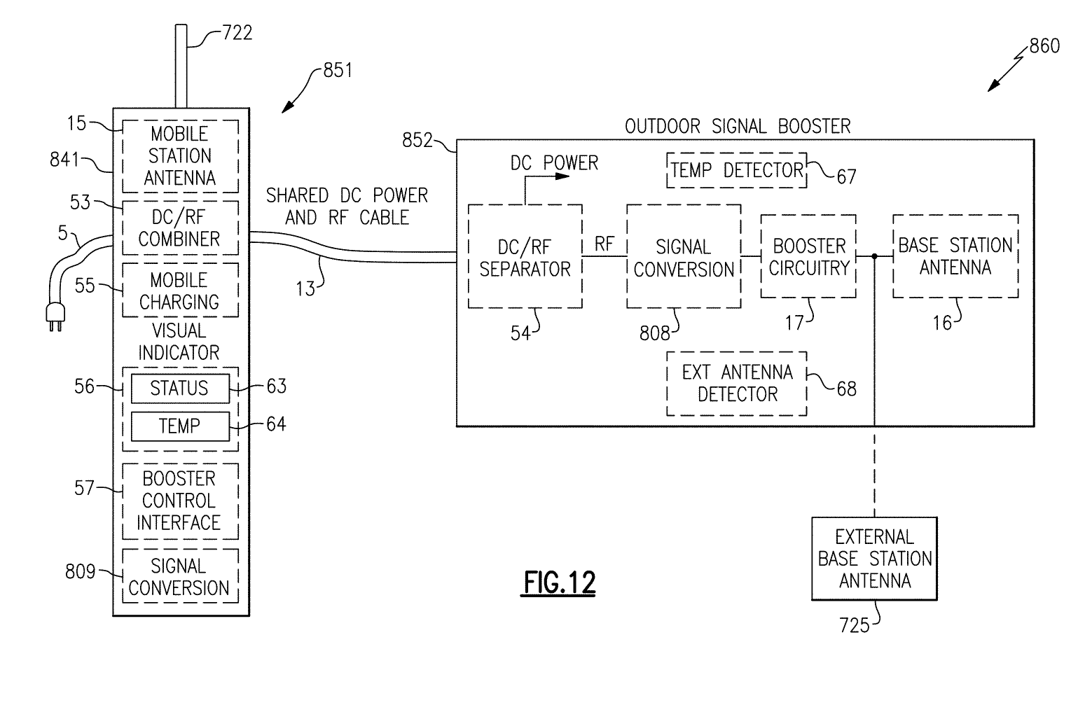

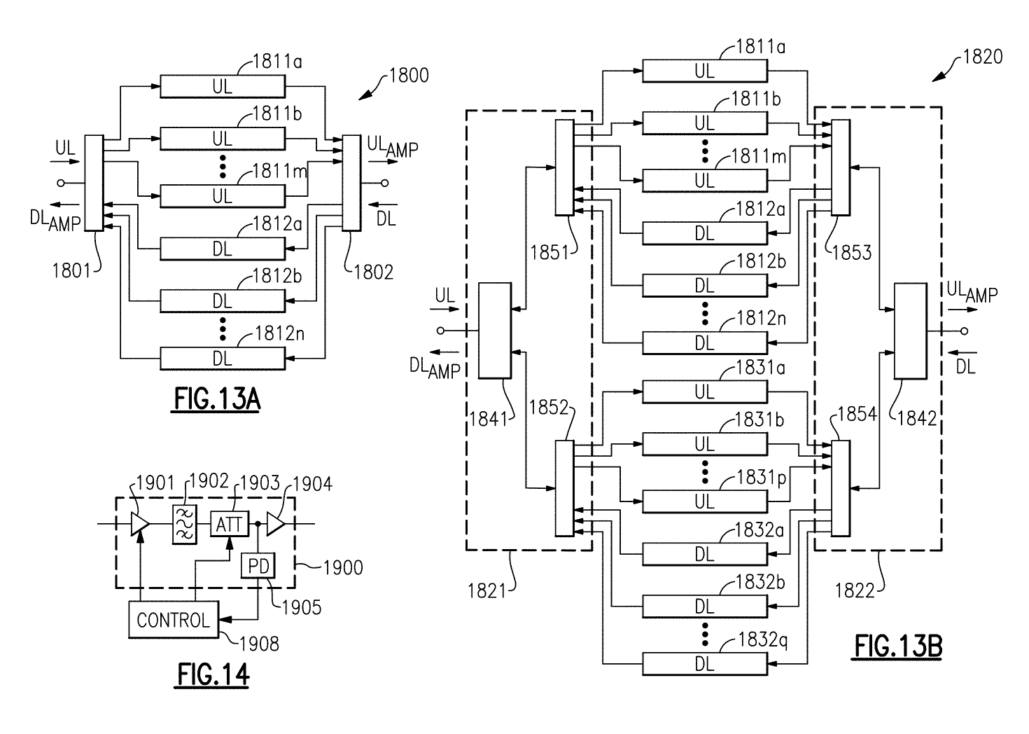

FIG. 13A is a schematic diagram of one embodiment of booster circuitry 1800. The booster circuitry 1800 of FIG. 13A corresponds to one embodiment of booster circuitry suitable for use in the signal booster systems disclosed herein. However, the signal booster systems herein can include other implementations of booster circuitry. The booster circuitry 1800 can operate using a wide variety of frequency bands and communication standards including, but not limited to, any of the frequency bands and communications standards described herein.

In the illustrated embodiment, the booster circuitry 1800 includes a first splitting/combining structure 1801 and a second splitting/combining structure 1802, which can be implemented in a wide variety of ways, including, but not limited to, using one or more multiplexers, one or more diplexers, one or more switches, and/or other suitable components for splitting and combining RF signals for a variety of types of communications, including, for example, FDD and/or TDD communications. The booster circuit 1800 further includes a group of uplink amplification circuits 1811a, 1811b, . . . 1811m and a group of downlink amplification circuits 1812a, 1812b, . . . 1812n.

In this embodiment, m uplink amplification circuits and n uplink amplification circuits are included in the booster circuitry 1800. The values of m and n can vary with application and/or implementation, and can be the same or different value.

As shown in FIG. 13A, the first splitting/combining structure 1801 receives an uplink signal (UL) and outputs an amplified downlink signal (DL_{AMP}). Additionally, the second splitting/combining structure 1802 receives a downlink signal (DL) and outputs an amplified uplink signal (UL_{AMP}).

In certain implementations, the first splitting/combining structure 1801 splits the received uplink signal (UL) into multiple uplink channel signals associated with uplink channels of multiple frequency bands. For example, each uplink channel signal can have a frequency range corresponding to the frequency range of an uplink channel of a particular frequency band. Additionally, the uplink amplification circuits 1811a, 1811b, . . . 1811m amplify the uplink channel signals to generate amplified uplink channel signals, which are combined by the second splitting/combining structure 1802 to generate the amplified uplink signal (UL_{AMP}). Additionally, the second splitting/combining structure 1802 splits the received downlink signal (DL) into multiple downlink channel signals associated with downlink channels of the frequency bands. For example, each downlink channel signal can have a frequency range corresponding to the frequency range of a downlink channel of a particular frequency band. Additionally, the downlink amplification circuits 1812a, 1812b, . . . 1812n amplify the downlink channel signals to generate amplified downlink channel signals, which are combined by the first splitting/combining structure 1801 to generate the amplified downlink signal (DL_{AMP}).

FIG. 13B is a schematic diagram of another embodiment of booster circuitry 1820. The booster circuitry 1820 of FIG. 13B corresponds to one embodiment of booster circuitry suitable for use in the signal booster systems disclosed herein. However, the signal booster systems herein can include other implementations of booster circuitry.

In the illustrated embodiment, the booster circuitry 1820 includes a first splitting/combining structure 1821, which includes a first diplexer 1841, a first multiplexer 1851, and a second multiplexer 1852. Additionally, the booster circuitry 1820 includes a second splitting/combining structure 1822, includes a second diplexer 1842, a third multiplexer 1853, and a fourth multiplexer 1854.

The booster circuit 1820 further includes a first group of uplink amplification circuits 1811a, 1811b, . . . 1811m, a first group of downlink amplification circuits 1812a, 1812b, . . . 1812n, a second group of uplink amplification circuits 1831a, 1831b, . . . 1831p, and a second group of downlink amplification circuits 1832a, 1832b, . . . 1832q. The values of m, n, p, and q can vary with application and/or implementation, and can be the same or different value.

In certain implementations, the first group of uplink amplification circuits 1811a, 1811b, . . . 1811m and the first group of downlink amplification circuits 1812a, 1812b, . . . 1812n provide amplification to signals less than a threshold frequency, while the second group of uplink amplification circuits 1831a, 1831b, . . . 1831p and the second group of downlink amplification circuits 1832a, 1832b, . . . 1832q provide amplification to signals greater than the threshold frequency.

FIG. 14 is a schematic diagram of one embodiment of an amplification circuit 1900. The amplification circuit or path 1900 of FIG. 14 illustrates one embodiment of an amplification circuit suitable for use as an uplink amplification circuit or downlink amplification circuit of a signal booster's booster circuitry. However, booster circuitry can include uplink and downlink amplification circuits implemented in a wide variety of ways. Accordingly, other implementations are possible.

In the illustrated embodiment, the amplification circuit 1900 includes a low noise amplifier 1901, a controllable attenuator 1902, a band filter 1903, a power amplifier 1904, and a power detector 1905.

In certain implementations, the detected power by the power detector 1905 is provided to control circuitry 1908 (for instance, a microprocessor, microcontroller, computer processing unit (CPU), and/or other suitable control circuitry). The control circuitry 1908 can use the detected power for a wide variety of functions, including, but not limited to, power control (for instance, automatic gain control), oscillation detection, and/or shutdown. In certain implementations, the control circuitry also provides control over gain of components of one or more RF amplification paths. For example, the control circuitry can control the attenuation provided by controllable attenuation components (for instance, digital step attenuators and/or voltage variable attenuators) and/or the gain provided by controllable amplification circuits (for instance, variable gain amplifiers and/or programmable gain amplifiers).

In certain implementations, the control circuitry 1908 is shared by multiple uplink amplification circuits and/or downlink amplification circuits. For example, the control circuitry 1908 can correspond to a processing chip (for instance, a microprocessor chip, microcontroller chip, or CPU chip) that provides centralized control of the signal booster system.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not only the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A signal booster system comprising:
a base station antenna configured to wirelessly receive an incoming downlink signal from one or more base stations of a cellular network;
a signal booster comprising:
booster circuitry configured to amplify the incoming downlink signal to generate a boosted downlink signal; and
a signal conversion circuit configured to convert the boosted downlink signal to an outgoing downlink signal of lower frequency; and
a mobile station antenna configured to receive the outgoing downlink signal from the signal booster via a cable, and to wirelessly transmit the outgoing downlink signal to one or more mobile devices of the cellular network.

2. The signal booster system of claim 1, wherein the incoming downlink signal comprises a licensed cellular signal and the outgoing downlink signal comprises an unlicensed RF signal.

3. (canceled)

4. The signal booster system of claim 2, wherein the unlicensed RF signal comprises a WiFi signal.

5. The signal booster system of claim 1, wherein the incoming downlink signal has a frequency greater than 6 GHz and the outgoing downlink signal has a frequency of less than 6 GHz.

6. (canceled)

7. The signal booster system of claim 1, wherein the signal conversion circuit is further configured to receive an incoming uplink signal from the mobile station antenna via the cable, and to convert the incoming uplink signal to an outgoing uplink signal of higher frequency.

8. The signal booster system of claim 7, wherein the incoming uplink signal comprises a licensed cellular signal and the outgoing uplink signal comprises an unlicensed RF signal.

9. (canceled)

10. (canceled)

11. (canceled)

12. The signal booster system of claim 1, wherein the signal booster further comprises a housing enclosing the booster circuitry and the signal conversion circuit.

13. (canceled)

14. (canceled)

15. The signal booster system of claim 12, further comprising a circuit board on which the booster circuitry and the signal conversion circuit reside.

16. The signal booster system of claim 15, further comprising an RF shield between the circuit board and the base station antenna.

17. The signal booster system of claim 1, wherein the mobile station antenna is integrated in a unit.

18. The signal booster system of claim 17, wherein the cable comprises a shared DC power and RF cable coupled between the unit and the signal booster.

19. (canceled)

20. (canceled)

21. (canceled)

22. (canceled)

23. (canceled)

24. (canceled)

25. (canceled)

26. (canceled)

27. The signal booster system of claim 17, wherein the unit comprises a booster control interface configured to control the signal booster.

28. The signal booster system of claim 1, wherein the signal booster comprises at least one of an umbrella, a heat sink, a fan, a shell coating, a sun visor, or a solar reflector for providing protection from overheating.

29. (canceled)

30. The signal booster system of claim 1, wherein the signal booster comprises a temperature detector, wherein the signal booster is configured to operate with backed-off gain in response to the temperature detector detecting a high temperature condition.

31. (canceled)

32. (canceled)

33. (canceled)

34. (canceled)

35. (canceled)

36. (canceled)

37. (canceled)

38. A signal booster system comprising:
a base station antenna configured to wirelessly receive an incoming downlink signal from one or more base stations of a cellular network;
a signal booster comprising:
booster circuitry configured to amplify the incoming downlink signal to generate a boosted downlink signal; and
a first signal conversion circuit configured to process the boosted downlink signal to generate a converted downlink signal of lower frequency;
a unit configured to receive the converted downlink signal from the signal booster via a cable, wherein the unit comprises a second signal conversion circuit configured to process the converted downlink signal to generate an outgoing downlink signal of higher frequency; and
a mobile station antenna configured to wirelessly transmit the outgoing downlink signal to one or more mobile devices of the cellular network.

39. (canceled)

40. (canceled)

41. The signal booster system of claim 38, wherein the incoming downlink signal has a frequency greater than 6 GHz and the converted downlink signal has a frequency of less than 6 GHz.

42. The signal booster system of claim 38, wherein the first signal conversion circuit comprises a downlink frequency downconversion circuit and the second signal conversion circuit comprises a downlink frequency upconversion circuit.

43. (canceled)

44. The signal booster system of claim 38, wherein the second signal conversion circuit is further configured to process an incoming uplink signal from the mobile station antenna to generate a converted uplink signal of lower frequency, and wherein the first signal conversion circuit is further configured to process the converted uplink signal to generate an outgoing uplink signal of higher frequency.

45. (canceled)

46. (canceled)

47. (canceled)

48. The signal booster system of claim 44, wherein the second signal conversion circuit comprises an uplink frequency downconversion circuit and the first signal conversion circuit comprises an uplink frequency upconversion circuit.

49. (canceled)

50. (canceled)

51. (canceled)

52. (canceled)

53. (canceled)

54. (canceled)

55. (canceled)

56. (canceled)

57. The signal booster system of claim 38, wherein the cable comprises a shared DC power and RF cable coupled between the unit and the signal booster.

58-77. (canceled)
